(19) United States
(12) Patent Application Publication
(10) Pub. No.: US 2021/0304081 A1
(43) Pub. Date: Sep. 30, 2021

(54) ACCOMMODATION AREA MANAGEMENT DEVICE

(71) Applicant: HONDA MOTOR CO., LTD., Tokyo (JP)

(72) Inventors: Gaku SHIMAMOTO, Saitama (JP); Junpei NOGUCHI, Saitama (JP); Yuta TAKADA, Tokyo (JP); Ryoma TAGUCHI, Tokyo (JP); Shogo KOBAYASHI, Saitama (JP)

(73) Assignee: HONDA MOTOR CO., LTD., Tokyo (JP)

(21) Appl. No.: 17/215,715

(22) Filed: Mar. 29, 2021

(30) Foreign Application Priority Data
Mar. 30, 2020 (JP) 2020-061639

(51) Int. Cl. G06Q 10/02; G06Q 50/30

(52) U.S. Cl. CPC G06Q 10/02; G06Q 50/30

(57) ABSTRACT

An accommodation area management device is configured to manage an accommodation area for accommodating a moving body and includes a reservation reception unit configured to receive a use reservation when the moving body uses the accommodation area, and an accommodation position determination unit configured to determine an accommodation position of the moving body. The reservation reception unit is configured to acquire information on the moving body when receiving the use reservation. The accommodation position determination unit is configured to set the accommodation position based on the information at the time of receiving the use reservation.

### CROSS-REFERENCE TO RELATED APPLICATIONS

This application is based on and claims priority under 35 USC 119 from Japanese Patent Application No. 2020-061639 filed on Mar. 30, 2020.

### TECHNICAL FIELD

The present disclosure relates to an accommodation area management device.

### BACKGROUND ART

Ina related art, in a mechanical multi-story parking lot, size measurement is performed to grasp a size of a vehicle before the vehicle enters the parking lot to check whether the vehicle can enter. For example, in a device for determining whether a vehicle can enter a parking lot disclosed in JP-A-H11-007600, the size of the vehicle is measured to check whether the vehicle can enter when the vehicle enters the parking lot in a case of a mechanical parking lot such as a pallet type or the like.

However, in the device for determining whether the vehicle can enter the parking lot disclosed in JP-A-H11-007600, if the size of the vehicle is measured when the vehicle enters the parking lot, a parking position satisfying a condition may be already in use and thus the vehicle cannot be parked therein, which makes it difficult to manage the parking lot smoothly. The above-described matter is not necessarily limited to the size of the vehicle.

### SUMMARY

The present disclosure provides an accommodation area management device capable of smoothly managing an accommodation area by securing an accommodation position satisfying a condition in advance.

According to the present disclosure, there is provided an accommodation area management device configured to manage an accommodation area for accommodating a moving body. The accommodation area management device includes a reservation reception unit configured to receive a use reservation when the moving body uses the accommodation area, and an accommodation position determination unit configured to determine an accommodation position of the moving body. The reservation reception unit is configured to acquire information on the moving body when receiving the use reservation. The accommodation position determination unit is configured to set the accommodation position based on the information at the time of receiving the use reservation.

According to the above accommodation area management device, an accommodation position satisfying a condition of a moving body can be secured in advance, and thus, an accommodation area can be smoothly managed.

### BRIEF DESCRIPTION OF DRAWINGS

FIG. 1 is a diagram illustrating an example of a configuration of a vehicle system according to an embodiment;

FIG. 2 is a diagram illustrating an example of a parking lot managed by a parking lot management device according to the embodiment:

FIG. 3 is a diagram illustrating an example of a configuration of the parking lot management device according to the embodiment:

FIG. 4 is a diagram illustrating an example of a parking space status table; and

FIG. 5 is a diagram illustrating an example of a parking space selection screen transmitted to the terminal device of the user.

### DESCRIPTION OF EMBODIMENTS

Hereinafter, an accommodation area management device according to an embodiment of the present disclosure will be described with reference to the accompanying drawings. In the following embodiment, a vehicle is an example of a moving body, and a parking lot is an example of an accommodation area. Further, in the following embodiment, a parking lot management device for managing the parking lot is an example of an accommodation area management device

[Vehicle System]

First, a vehicle of the embodiment (hereinafter, also referred to as a vehicle M) will be described.

The vehicle of the embodiment (hereinafter, also referred to as the vehicle M) is an automobile including a drive source (for example, a traveling driving force output device 200 which will be described later) and wheels (for example, two wheels, three wheels, or four wheels) including a drive wheel driven by the power of the drive source. As the drive source of the vehicle M, for example, there are an electric motor, an internal combustion engine (for example, a gasoline engine), or a combination of the electric motor and the internal combustion engine.

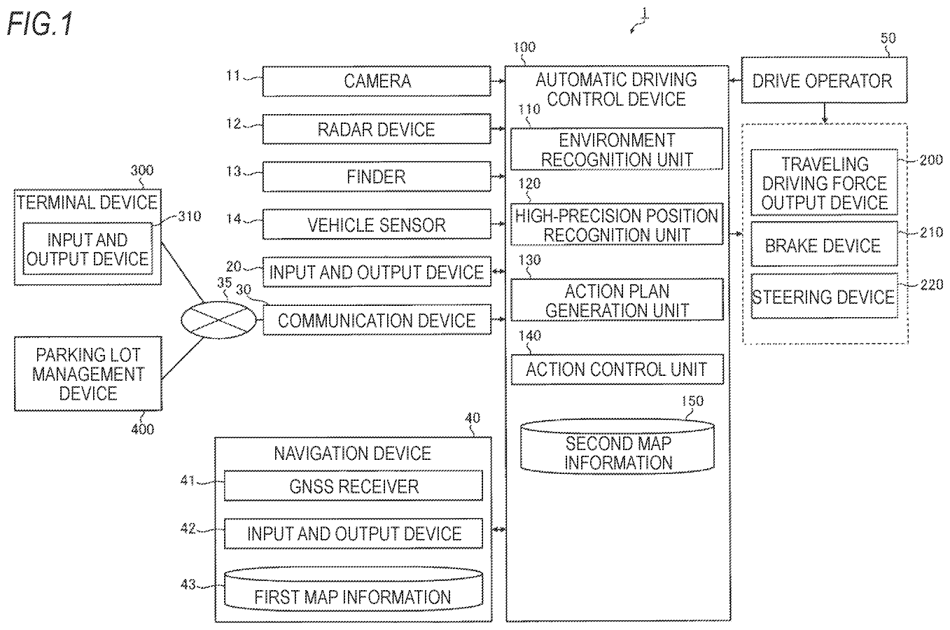

Further, the vehicle M includes a vehicle system 1 illustrated in FIG. 1. The vehicle system 1 has a function capable of performing all driving tasks related to the vehicle M at least in a limited specific area (for example, in a parking lot PA which will be described later). Here, the driving task is, for example, a real-time driving function required for operating the vehicle M, such as controlling the movement of the vehicle M in the left-right direction (steering), controlling the movement in the front-rear direction (acceleration and deceleration), monitoring the driving environment, or the like, and a tactical function such as planning of a traveling track. The vehicle M is a vehicle including a drive source and wheels (for example, two wheels, three wheels, or four wheels) including a drive wheel driven by the power of the drive source.

As illustrated in FIG. 1, the vehicle system 1 includes a camera 11, a radar device 12, a finder 13, a vehicle sensor 14, an input and output device 20, a communication device 30, a navigation device 40, a driving operator 50, an automatic driving control device 100, a traveling driving force output device 200, a brake device 210, and a steering device 220. The respective devices are communicably connected to each other via a wired or wireless communication network. The communication network connecting the respective devices is, for example, a Controller Area Network (CAN).

The camera 11 is a digital camera which images the periphery of the vehicle M (for example, in front of the vehicle M), and outputs the image data obtained by imaging the periphery thereof to the automatic driving control device 100. The radar device 12 is, for example, a radar device using radio waves in a millimeter wave band, detects a position of an object in the periphery of the vehicle M (for example, the front, the rear, and the side of the vehicle M), and outputs the detection result to the automatic driving control device 100.

The finder 13 is, for example, Laser Imaging Detection and Ranging (LIDAR), uses a predetermined laser beam to measure a distance to the object (a target object) existing in the periphery of the vehicle M (for example, the front, the rear, and the side of the vehicle M), and outputs a measurement result of the distance to the automatic driving control device 100.

The vehicle sensor 14 includes, for example, a vehicle speed sensor which detects the speed of the vehicle M, an acceleration sensor which detects the acceleration of the vehicle M, an angular velocity sensor which detects the angular velocity around the vertical axis of the vehicle M, and an orientation sensor which detects the direction of the vehicle M, or the like. Further, the vehicle sensor 14 includes a radio wave intensity sensor which detects the radio wave intensity (that is, a communication intensity) of radio waves used for communication by the communication device 30. The vehicle sensor 14 outputs the detection result of each sensor to the automatic driving control device 100.

The input and output device 20 includes an output device which outputs various information to a user of the vehicle M, and an input device which receives various input operations from the user of the vehicle M (hereinafter, also simply referred to as a user). In the embodiment, the user is not limited to a person who manages or owns the vehicle M and uses the vehicle M. For example, the user may be a person who uses the vehicle M on behalf of the person who manages or owns the vehicle M at the request of the person who manages or owns the vehicle M. The output device of the input and output device 20 is, for example, a display which performs displaying based on the processing result of the automatic driving control device 100. The output device may be a speaker, a buzzer, an indicator light, or the like. Further, the input device of the input and output device 20 is, for example, a touch panel or an operation button (a key, a switch, or the like) which outputs an operation signal corresponding to the input operation received from the user to the automatic driving control device 100.

The communication device 30 is wirelessly connected to a network 35 and communicates with another device provided outside the vehicle system 1 via the network 35. The network 35 is, for example, a mobile communication network, a Wi-Fi network, Bluetooth (registered trademark), Dedicated Short Range Communication (DSRC), or the like.

The communication device 30 communicates with, for example, a terminal device 300 carried by the user and a parking lot management device 400 which manages a parking lot PA in which the vehicle M can be parked. The terminal device 300 is, for example, a smartphone, a tablet terminal, or the like, and is an electronic device connected to the network 35 and including an input and output device 310. The input and output device 310 is, for example, a display, which displays various information to the user, a touch panel, which receives the input operation of the user, or the like. The parking lot PA and the parking lot management device 400 will be described later.

The navigation device 40 includes a Global Navigation Satellite System (GNSS) receiver 41 and an input and output device 42. Further, the navigation device 40 includes a storage device (not illustrated) such as a hard disk drive (hereinafter, also referred to as an HDD), a flash memory, or the like, and first map information 43 is stored in the storage device. The first map information 43 is, for example, information representing a road shape by a link indicating a road and anode connected by the link. Further, the first map information 43 may include information representing the curvature of the road and a Point Of Interest (POI).

The GNSS receiver 41 specifies the latitude and longitude of a point where the vehicle M is positioned as the position of the vehicle M based on the signal received from a GNSS satellite. Further, the navigation device 40 may specify or correct the position of the vehicle M by an Inertial Navigation System (INS) using the output of the vehicle sensor 14.

The input and output device 42 includes an output device, which outputs various information to the user and an input device, which receives various input operations from the user. The output device of the input and output device 42 is, for example, a display which performs displaying based on the processing result of the navigation device 40 (for example, displays a route on the map, which will be described later). Further, the input device of the input and output device 42 is, for example, a touch panel or an operation button (a key, a switch, or the like) which outputs the operation signal corresponding to the input operation received from the user to the navigation device 40. The input and output device 42 may be shared with the input and output device 20.

Although the detailed description is omitted, for example, the navigation device 40 determines a route from the position of the vehicle M specified by the GNSS receiver 41 to the destination inputted by the user (hereinafter, also referred to as the route on the map) with reference to the first map information 43. Next, the navigation device 40 guides the determined route on the map to the user by the input and output device 42. Further, the navigation device 40 outputs information indicating the specified position of the vehicle M and information indicating the determined route on the map to the automatic driving control device 100.

Further, a part or all of the functions of the navigation device 40 may be realized by the function of the terminal device 300. Further, a part or all of the functions of the navigation device 40 may be realized by an external server device (a navigation server) capable of communicating with the vehicle system 1 by the communication device 30 or the like.

The driving operator 50 is various operators such as an accelerator pedal, a brake pedal, a shift lever, a steering wheel, a variant steering wheel, a joystick, and the like. The driving operator 50 is provided with a sensor, which detects the amount of the operation or the presence or absence of operation on the driving operator 50. The detection result by the sensor of the driving operator 50 is outputted to a part or all of the automatic driving control device 100, the traveling driving force output device 200, the brake device 210, and the steering device 220.

The traveling driving force output device 200 outputs the traveling driving force (torque) for the vehicle M to travel to the drive wheel. The traveling driving force output device 200 includes, for example, an electric motor and an electric motor Electronic Control Unit (ECU) which controls the electric motor. The electric motor ECU controls the electric motor based on the detection result by the sensor of the driving operator 50 (for example, the accelerator pedal) and control information from the automatic driving control device 100. Further, when the vehicle M includes an internal combustion engine and a transmission as a drive source, the traveling driving force output device 200 may include the internal combustion engine, the transmission, and the ECU which controls the internal combustion engine and the transmission.

The brake device 210 includes, for example, a brake caliper, a cylinder which transmits hydraulic pressure to the brake caliper, an electric motor which generates the hydraulic pressure in the cylinder, and a brake ECU. The brake ECU controls the electric motor of the brake device 210 based on the detection result by the sensor of the driving operator 50 (for example, the brake pedal) and the control information from the automatic driving control device 100, and outputs the brake torque in accordance with a brake operation to each wheel.

The steering device 220 includes, for example, a steering ECU and an electric motor. The electric motor of the steering device 220 changes the direction of the steering wheel by, for example, applying a force to a rack and pinion mechanism. The steering ECU drives the electric motor of the steering device 220 based on the detection result by the sensor of the driving operator 50 (for example, the steering wheel) and the control information from the automatic driving control device 100, and changes the direction of the steering wheel (that is, a steering angle).

[Automatic Driving Control Device]

The automatic driving control device 100 includes an environment recognition unit 110, a high-precision position recognition unit 120, an action plan generation unit 130, and an action control unit 140. Further, the automatic driving control device 100 includes a storage device (not illustrated) realized by a flash memory or the like accessible to each functional unit (for example, the high-precision position recognition unit 120) of the automatic driving control device 100, and second map information 150 is stored in the storage device.

The second map information 150 is more accurate map information than the first map information 43. The second map information 150 includes, for example, information indicating the center of a lane, information indicating a lane boundary line (for example, a road lane marking), and the like. The second map information 150 may include road information, traffic regulation information, address information, facility information, telephone number information, and the like.

Further, the second map information 150 may be updated at any time when the communication device 30 communicates with another device. For example, when the vehicle M enters the parking lot PA, the communication device 30 receives information indicating the lanes in the parking lot PA, the position of each parking space PS, and the like (hereinafter, also referred to as map information in the parking lot) from the parking lot management device 400. Next, the automatic driving control device 100 updates the second map information 150 to incorporate the received map information in the parking lot into the second map information 150. As a result, the automatic driving control device 100 can specify the position of each parking space PS in the parking lot PA, or the like with reference to the second map information 150. Further, the second map information 150 may be updated when the communication device 30 communicates with a server which distributes the map information or the like.

The environment recognition unit 110 performs sensor fusion processing on the information to be acquired by a part or all of the camera 11, the radar device 12, and the finder 13, recognizes an object existing in the periphery of the vehicle M and also recognizes the position of the object. The environment recognition unit 110 recognizes, for example, obstacles, road shapes, traffic lights, guardrails, utility poles, surrounding vehicles (including the traveling status such as the speed, acceleration, or the like, and parking state), lane marks, pedestrians, or the like, and also recognizes positions thereof.

The high-precision position recognition unit 120 recognizes the detailed position and posture of the vehicle M with reference to the position of the vehicle M specified by the navigation device 40, the detection result by the vehicle sensor 14, the image taken by the camera 11, the second map information, or the like. The high-precision position recognition unit 120 recognizes, for example, the traveling lane on which the vehicle M is traveling, or recognizes a relative position and a posture of the own vehicle with respect to the traveling lane. The high-precision position recognition unit 120 also recognizes, for example, the position of the vehicle M in the parking lot PA, or the like.

The action plan generation unit 130 generates an action plan of the vehicle M. Specifically, the action plan generation unit 130 generates a target track on which the vehicle M will travel in the future as an action plan of the vehicle M. For example, the target track is information represented by arranging points (track points) to be reached by the vehicle M for each predetermined traveling distance (for example, about several [m]). Further, the target track may include information on speed elements such as the target speed, the target acceleration, and the like of the vehicle M at each predetermined time or at each track point. The action plan generation unit 130 generates the action plan, for example, according to an instruction of the parking lot management device 400 received by the communication device 30.

The action control unit 140 controls the vehicle M to act according to the action plan generated by the action plan generation unit 130. Specifically, the action control unit 140 controls the traveling driving force output device 200, the brake device 210, and the steering device 220 so that the vehicle M passes the target track generated by the action plan generation unit 130 at the scheduled time. The action control unit 140 controls, for example, the traveling driving force output device 200 and the brake device 210 based on the speed element associated with the target track, or controls the steering device 220 according to a curvature degree of the target trajectory.

Each functional unit provided in the automatic driving control device 100 is realized, for example, by a central processing unit (CPU) executing a predetermined program (software). A part or all of the functional units of the automatic driving control device 100 may be realized by hardware, such as Large Scale Integration (LSI), an Application Specific Integrated Circuit (ASIC), a Field-Programmable Gate Array (FPGA), and a Graphics Processing Unit (GPU), or the like, and for example, the storage device for storing the second map information 150 and the high-precision position recognition unit 120 may be realized by a Map Positioning Unit (MPU). A part or all of the functional units of the automatic driving control device 100 may be realized by the cooperation of the software and the hardware.

[Parking Lot Managed by Parking Lot Management Device]

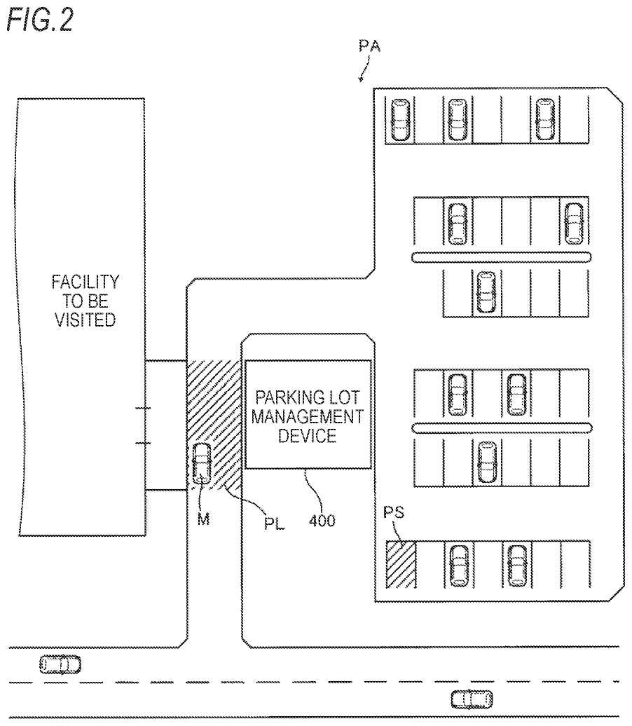

Next, an example of the parking lot PA will be described with reference to FIG. 2. As illustrated in FIG. 2, the parking lot PA is a parking lot managed by the parking lot management device 400 and is an automatic valet parking type parking lot provided as an annex in a visiting facility to be visited by a user. The parking lot PA includes a plurality of parking spaces PS capable of accommodating a vehicle (for example, the vehicle M) and a boarding area PL provided in front of the plurality of parking spaces PS.

Hereinafter, an example in which the user of the vehicle M uses the parking lot PA will be described.

The user of the vehicle M rides the vehicle M on the boarding area PL, and gets off from the vehicle M at the boarding area PL.

After the user gets off the vehicle M, the vehicle M performs automatic driving and starts a self-propelled entry event to move the vehicle M to the parking space PS in the parking lot PA. For example, the user transmits a request for starting the self-propelled entry event to the parking lot management device 400 by using the terminal device 300. In response to the request, the parking lot management device 400 instructs the vehicle M to perform the self-propelled entry event for allowing the vehicle M to be parked in a predetermined parking space PS. According to this instruction, the vehicle M moves to the parking space PS instructed by the parking lot management device 400 while being guided by the parking lot management device 400 and performing sensing by the camera 11, the radar device 12 or the finder 13 or the like. As a result, the vehicle M is parked at the parking space PS instructed by the parking lot management device 400 as a parking position.

Further, when the vehicle M exits, the vehicle M performs the automatic driving and performs a self-propelled exit event to move the vehicle M from the parking space PS to the boarding area PL. For example, the user transmits a request for starting the self-propelled exit event to the parking lot management device 400 by using the terminal device 300. In response to the request, the parking lot management device 400 instructs the vehicle M to perform the self-propelled exit event to move the vehicle M from the parking space PS, where the vehicle M is parked, to the boarding area PL. According to this instruction, the vehicle M moves to the boarding area PL while being guided by the parking lot management device 400 and performing sensing by the camera 11, the radar device 12, the finder 13, or the like. The user of the vehicle M gets on the vehicle M at the boarding area PL and exits from the parking lot PA.

[Parking Lot Management Device]

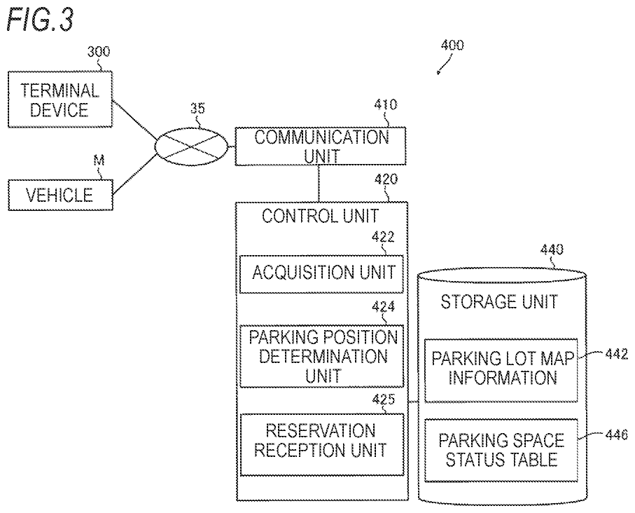

Next, an example of a configuration of the parking lot management device 400 will be described with reference to FIG. 3. As illustrated in FIG. 3, the parking lot management device 400 includes, for example, a communication unit 410, a control unit 420, and a storage unit 440. The control unit 420 includes, for example, an acquisition unit 422, a parking position determination unit 424, and a reservation reception unit 425. Each component of the control unit 420 may be realized, for example, by a hardware processor such as a CPU executing a program (software). A part or all of these components may be realized by hardware such as LSI, an ASIC, an FPGA, a GPU, and the like (including a circuit unit; circuitry), or may be realized by the cooperation of the software and the hardware. The program may be stored in advance in a storage device, such as an HDD, a flash memory, and the like (a storage device including a non-transient storage medium), may be stored in a removable storage medium (the non-transient storage medium) such as a DVD, a CD-ROM, or the like and may be installed by attaching the storage medium to a drive device, and may be a program managed by another server and executed.

Information such as parking lot map information 442, a parking space state table 446, or the like is stored in the storage unit 440. The storage unit 440 is realized by an HDD, a flash memory, or the like.

The communication unit 410 wirelessly (for example, the network 35) communicates with the vehicle M or the terminal device 300 of the user. The control unit 420 guides the vehicle M to the parking space PS based on the information acquired via the communication unit 410 and the information stored in the storage unit 440. The parking lot map information 442 is information which geometrically represents a structure of the parking lot PA. Further, the parking lot map information 442 includes coordinates for each parking space PS.

The reservation reception unit 425 receives a use reservation via the communication unit 410 when the vehicle M uses the parking lot PA. In addition to a date and time (including scheduled entry time) and identification information of the vehicle M to be used when receiving the use reservation, the reservation reception unit 425 acquires information including the size of the vehicle M or the type thereof (hereinafter, may be referred to as vehicle information) when receiving the use reservation. The identification information of the vehicle M is, for example, a vehicle number of a vehicle number plate (so-called a license plate), a chassis number, or the like. The reservation reception unit 425 is not necessarily limited to acquiring the vehicle information from the vehicle M and the terminal device 300 of the user, but may receive the use reservation from a device installed in the parking lot PA (for example, the entrance gate of the parking lot PA).

For example, the size of the vehicle M may be information including the total length and the vehicle width or may be information including the total length, the vehicle width, and the vehicle height. The type of the vehicle M may be separately represented such as a full-sized vehicle, a one-box vehicle, a medium-sized vehicle, a compact vehicle, or the like. The type of the vehicle M is information for deriving the size of the vehicle M.

Further, the vehicle information can include information on a load loaded on the vehicle M or a towed vehicle to be towed by the vehicle M. The load includes a storage box, a carrier, a bag, a ski, a snowboard, or the like fixed to a roof. The towed vehicle is a trailer, a container, a loading platform, a passenger car, or the like. Similar to those of the size and the type of the vehicle M, the load and the towed vehicle are also information to be used when the parking position is selected.

For example, the reservation reception unit 425 may input the size of the vehicle M from a plurality of choices on a reservation screen for receiving the use reservation, may select a model and the type of the vehicle thereon, and may directly input information related to the size of the vehicle M thereon. Further, the reservation reception unit 425 selects the presence or absence of a load or a towed vehicle on the reservation screen for receiving the use reservation. Further, when there is a load or a towed vehicle, the reservation reception unit 425 may select the size of the load or the towed vehicle. The reservation reception unit 425 may set the vehicle information as a required input item so that the use reservation cannot be transmitted unless the vehicle information is inputted.

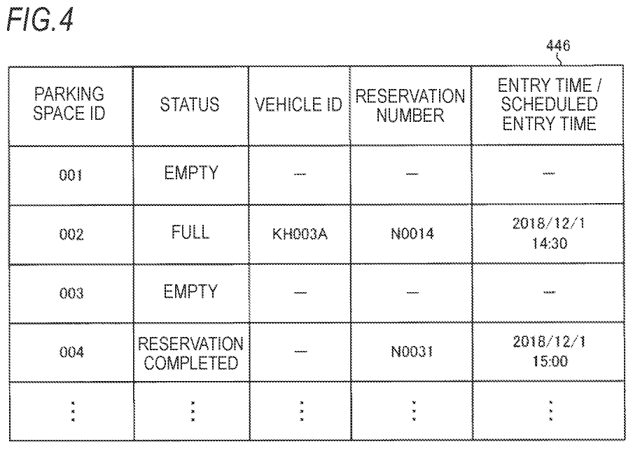

The acquisition unit 422 acquires parking space information of the vehicle M already being parked in the parking lot PA and parking space information of the vehicle M already being reserved for use in the parking lot PA via the communication unit 410. The parking space information is stored, for example, in the form of the parking space status table 446. As illustrated in FIG. 4, the parking space status table 446 includes: for example, information indicating whether a parking space ID, which is identification information of the parking space PS, is in a vacant status, a full (parked) status, or a reserved status; a vehicle ID which is the identification information of the parked vehicle M when the parking space ID is in the full status; the entry time of the vehicle M when the parking space ID is in the full status; a reservation number when the parking space ID is in the reserved status; and the scheduled entry time when the parking space ID is in the reserved status. The entry time is recorded in association with the vehicle ID of the vehicle M when the vehicle M enters the parking space PS. The scheduled entry time is recorded in association with the reservation number when the reservation is completed.

The parking position determination unit 424 sets the parking position of the vehicle M at the time of receiving the reservation based on the vehicle information acquired by the reservation reception unit 425 and the parking space information acquired by the acquisition unit 422. In this manner, since the parking position determination unit 424 sets a parking position of the vehicle M at the time of receiving the reservation based on the vehicle information including the size or the type of the vehicle M acquired at the time of receiving the use reservation, a parking position satisfying the condition of the vehicle M can be secured in advance, such that the parking lot PA can be smoothly managed. More specifically, the parking position determination unit 424 selects a candidate parking space PS, in which the vehicle M can be parked, based on the vehicle information acquired by the reservation reception unit 425 from among the parking spaces PS which can be reserved, with reference to the position information of the vehicle M already being parked and the position information of the vehicle M already being reserved acquired by the acquisition unit 422.

Further, when the information on the load loaded on the vehicle M or the towed vehicle towed by the vehicle M is included at the time of making a use reservation, the parking position determination unit 424 selects a parking space PS based on the size or the type of the vehicle M and the information on the load or the towed object acquired by the reservation reception unit 425, and the parking space information acquired by the acquisition unit 422.

Then, the parking position determination unit 424 provides parking position information on the selected parking space PS to the vehicle M or the terminal device 300 of the user via the communication unit 410. The parking position information on the selected parking space PS may include a plurality of candidate parking spaces PS or may include only one optimum parking space PS.

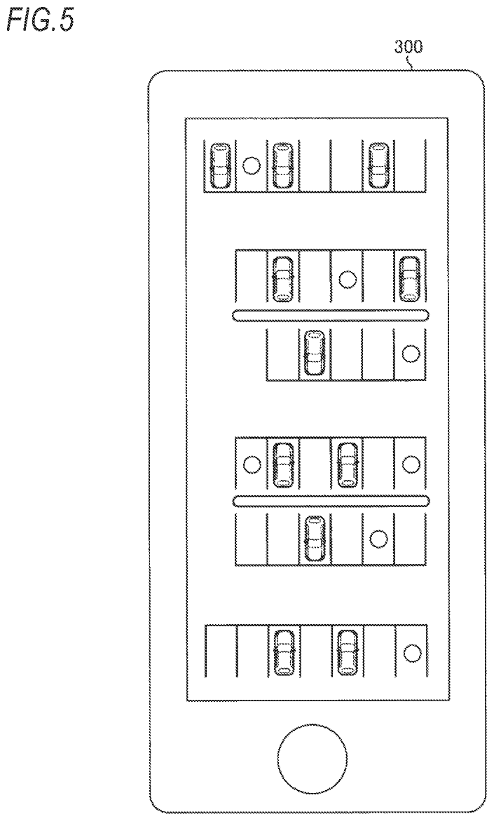

When the plurality of candidate parking spaces PS are provided as the parking position information, for example, as illustrated in FIG. 5, the user looks at a received parking space selection screen and can select a desired parking space PS from among the plurality of candidate parking spaces (for example, a circle mark in FIG. 5). The user may select a parking space PS close to the boarding area PL or may select a parking space PS with a roof. In the case of a vehicle capable of performing solar power generation, the user can also select a sunny parking space PS without the roof.

In this case, when acquiring the designation of one parking space PS among the plurality of candidate parking spaces PS from the user, the parking position determination unit 424 sets the designated parking space PS as a confirmed parking position. As a result, the user can designate a desired parking space PS at the time of making a reservation, such that the convenience of the parking lot PA is further improved.

On the other hand, when only one parking space PS is provided as the parking position information, the parking position determination unit 424 can select one parking space PS suitable for the vehicle M with respect to the user and/or the parking lot management device 400 based on the vehicle information, from among the plurality of parking spaces PS provided in the parking lot PA. For example, when the vehicle M is a towing vehicle, the parking space PS suitable for the vehicle M may be a parking space PS which can secure a wide route through which a towed trailer or the like can sufficiently pass, or may be a parking space PS closest to the boarding area PL. In this manner, the parking position determination unit 424 selects a parking space PS suitable for the vehicle M from among the plurality of parking spaces PS provided in the parking lot PA, thereby making it possible to smoothly manage the parking lot PA.

In this case, the parking position determination unit 424 provides the parking position information on the selected parking space PS to the vehicle M or the terminal device 300 of the user via the communication unit 410. As a result, when the reservation reception unit 425 acquires permission of the user regarding the parking position information, the selected parking space PS is set as the confirmed parking position. As a result, the user can acquire the parking position information at the time of making the reservation, such that the convenience of the parking lot PA is improved.

When the reservation reception unit 425 acquires non-permission of the user regarding the parking position information, the parking position determination unit 424 selects another parking space PS which becomes a candidate based on the vehicle information acquired by the reservation reception unit 425, and provides the parking position information on the other selected parking space PS to the vehicle M or the terminal device 300 of the user until the permission of the user is acquired. Accordingly, the user can designate a desired accommodation position at the time of making the reservation, such that the convenience of the parking lot PA is further improved.

The reservation reception unit 425 confirms the use reservation when the parking position determination unit 424 sets the confirmed parking position. It is desirable to provide the vehicle M or the terminal device 300 of the user with an entry license which permits the entry into the parking lot PA. The entry license which permits entry into the parking lot PA is an entry permit for the parking lot PA, an entry code, or the like. As a result, a procedure when the vehicle M enters the parking lot PA can be simplified, such that the convenience of the parking lot PA is further improved.

Further, when confirming the use reservation, the reservation reception unit 425 causes the reservation number, the scheduled entry time, and the parking space PS which has become the confirmed parking position to be associated with each other, and stores the associated reservation number, scheduled parking-space entry time, and parking space PS in the form of, for example, the parking space state table 446.

When there is no candidate parking space PS in the parking lot PA, the reservation reception unit 425 notifies the vehicle M or the terminal device 300 of the user that there is no parking space PS in which the vehicle M can be parked. By performing this notification, the user can understand the situation in advance and can avoid coming to the parking lot PA where there is no parking space PS suitable for the vehicle M. Further, when there is no candidate parking space PS in the parking lot PA, the parking lot management device 400 does not issue the entry license, thereby making it possible to prevent a situation in which the vehicle M cannot travel in the parking lot PA in advance.

Further, when there is no candidate parking space PS in the parking lot PA, in addition to the above-described situation, the reservation reception unit 425 may provide the user with the vehicle information such as the type or the like of a vehicle which can be parked. For example, when the user owns a plurality of vehicles, the user may be able to use the parking lot PA with the vehicle which can be parked by knowing the type of vehicle which can be parked.

Further, when there is no candidate parking space PS in the parking lot PA, in addition to the above-described situation, the reservation reception unit 425 may provide parking lot information on other parking lots including a parking space in which the vehicle M can be parked. As a result, the user can select an appropriate parking lot in advance, and the parking lot management device 400 can increase the use opportunity of other parking lots.

When the vehicle M enters the parking lot PA, the parking position determination unit 424 determines whether the vehicle M is permitted to enter the parking lot PA based on the vehicle information. More specifically, the parking position determination unit 424 acquires the vehicle information when the vehicle M enters the parking lot PA, and compares the vehicle information when the vehicle M enters the parking lot PA with the vehicle information acquired by the reservation reception unit 425. Next, if the vehicle information when the vehicle M enters the parking lot PA is the same as the vehicle information acquired by the reservation reception unit 425, the vehicle M is permitted to enter the parking lot PA. On the other hand, if the vehicle information when the vehicle M enters the parking lot PA is different from the vehicle information acquired by the reservation reception unit 425, the vehicle M is not permitted to enter the parking lot PA.

Further, even though the vehicle information when the vehicle M enters the parking lot PA is different from the vehicle information acquired by the reservation reception unit 425, the vehicle M may be permitted to enter the parking lot PA if the size of the vehicle M when the vehicle M enters the parking lot PA is smaller than the size of the vehicle M acquired by the reservation reception unit 425. Further, even if the size of the vehicle M when the vehicle M enters the parking lot PA is larger than the size of the vehicle M acquired by the reservation reception unit 425, the vehicle M may be permitted to enter the parking lot PA when there is a parking space PS which can accommodate the vehicle M. In this case, the parking position determination unit 424 changes the confirmed parking position set by the reservation reception unit 425 based on the vehicle information when the vehicle M enters the parking lot PA.

The parking position determination unit 424 may acquire the vehicle information when the vehicle M enters the parking lot PA from an imaging device, which is not illustrated, provided at the entrance gate of the parking lot PA, or may request the user of the vehicle M to input the vehicle information when the vehicle M enters the parking lot PA.

In this manner, the vehicle information is confirmed when the vehicle M enters the parking lot PA, such that it is possible to prevent in advance the situation in which the vehicle M cannot be parked in the parking lot PA because the size of the vehicle M at the time of entry is larger than that at the time of receiving the reservation.

The embodiment describes a case in which a so-called vehicle is parked in a parking lot. However, the inventive concept of the present invention is not limited to such an embodiment and is also applied to a moving body including a vehicle (for example, a robot). That is, the present disclosure also includes a case where the moving body is accommodated in an accommodation area where the moving body can be accommodated. In consideration of this idea, “parking” is extended to a concept of “stop”, and the “parking lot management device” of the embodiment is extended to a concept of the “accommodation area management device”.

While a mode for implementing the present disclosure is described above by using the embodiment, the inventive concept of the present invention is not limited to the embodiment, and various modifications and substitutions can be added within the scope not departing from the gist of the present disclosure.

Further, at least the following items are described in this specification. Components or the like corresponding to the above-described embodiments are shown in parentheses, but the present disclosure is not limited thereto.

(1) An accommodation area management device (parking lot management device 400) configured to manage an accommodation area (parking lot PA) for accommodating a moving body (vehicle M), the accommodation area management device includes:

a reservation reception unit (reservation reception unit 425) configured to receive a use reservation when the moving body uses the accommodation area; and

an accommodation position determination unit (parking position determination unit 424) configured to determine an accommodation position of the moving body, wherein:

the reservation reception unit is configured to acquire information on the moving body (vehicle information) when receiving the use reservation; and

the accommodation position determination unit is configured to set the accommodation position based on the information at the time of receiving the use reservation.

According to the accommodation area management device of (1), since the accommodation position determination unit is configured to set the accommodation position at the time of receiving the reservation based on the information on the moving body acquired at the time of receiving the use reservation, the accommodation position satisfying the condition can be secured in advance, thereby making it possible to smoothly manage the accommodation area.

(2) In the accommodation area management device according to (1),

the accommodation position determination unit is configured to select a candidate accommodation position (parking position) based on the information acquired by the reservation reception unit;

the accommodation position determination unit is configured to provide a user of the moving body with accommodation position information on the candidate accommodation position; and

the accommodation position determination unit is configured to set the candidate accommodation position as a confirmed accommodation position when the reservation reception unit acquires permission of the user regarding the accommodation position information.

According to the accommodation area management device of (2), since the user can know the accommodation position at the time of making a reservation, the convenience of the accommodation area is improved.

(3) In the accommodation area management device according to (2),

when the reservation reception unit acquires non-permission of the user regarding the accommodation position information, the accommodation position determination unit is configured to select another candidate accommodation position based on the information acquired by the reservation reception unit, and provides the user with accommodation position information on another candidate accommodation position.

According to the accommodation area management device of (3), since the user can designate the desired accommodation position at the time of making the reservation, the convenience of the accommodation area is further improved.

(4) In the accommodation area management device according to (1) or (2),

the accommodation position determination unit is configured to select a plurality of candidate accommodation positions based on the information acquired by the reservation reception unit;

the accommodation position determination unit is configured to provide a user of the moving body with accommodation position information on the plurality of candidate accommodation positions; and

when the reservation reception unit acquires a designation of one of the plurality of candidate accommodation positions, the accommodation position determination unit is configured to set the one of the plurality of candidate accommodation positions as a confirmed accommodation position.

According to the accommodation area management device of (4), since the user can designate the desired accommodation position from the plurality of accommodation positions at the time of making the reservation, the convenience of the accommodation area is improved.

(5) In the accommodation area management device according to (2) or (4),

when the accommodation position determination unit sets the confirmed accommodation position, the reservation reception unit is configured to provide the user with an entry license permitting entry into the accommodation area.

According to the accommodation area management device of (5), since the reservation reception unit is configured to provide the entry license permitting the entry into the accommodation area when the accommodation position determination unit determines the accommodation position, the user can omit or simplify the procedure when entering the accommodation area, thereby further improving the convenience of the accommodation area.

(6) In the accommodation area management device according to (2), (4) or (5),

if the information acquired when the use reservation is received and information on the moving body when the moving body enters the accommodation area are different from each other, the accommodation position determination unit is configured to change the confirmed accommodation position.

According to the accommodation area management device of (6), a situation in which the moving body cannot be accommodated in the accommodation position in the accommodation area can be prevented in advance.

(7) In the accommodation area management device according to any one of (1) to (5),

when there is no candidate accommodation position in the accommodation area, the reservation reception unit is configured to notify the user of the moving body that there is no accommodation position capable of accommodating the moving body.

According to the accommodation area management device of (7), the user can know in advance that the desired accommodation position does not exist in the accommodation area and can avoid coming to the accommodation area where the accommodation position does not exist. Further, it is possible to prevent in advance a situation in which the moving body cannot travel in the accommodation area.

(8) In the accommodation area management device according to (7),

when there is no candidate accommodation position in the accommodation area, the reservation reception unit is configured to provide the user with accommodation area information on another accommodation area including an accommodation position capable of accommodating the moving body.

According to the accommodation area management device of (8), when there is no candidate accommodation position in the accommodation area, the reservation reception unit provides the user with the accommodation area information on another accommodation area including an accommodation position capable of accommodating the moving body, such that the user can select an appropriate accommodation area in advance.

(9) In the accommodation area management device according to (7),

when there is no candidate accommodation position in the accommodation area, the reservation reception unit is configured to provide the user with information on a moving body which can be accommodated.

According to the accommodation area management device of (9), the user changes the current moving body to a moving body which can be accommodated based on the information from the reservation reception unit, thereby making it possible to use the accommodation area.

(10) In the accommodation area management device according to any one of (1) to (9),

the information includes information on a size or a type of the moving body; and

the accommodation position determination unit is configured to select the accommodation position capable of accommodating the moving body based on the information from among a plurality of accommodation positions provided in the accommodation area.

According to the accommodation area management device of (10), since the accommodation position determination unit is configured to select the accommodation position based on the information on the size or the type of the moving body acquired at the time of receiving the use reservation, it is possible to avoid the situation in which the moving body cannot be accommodated in the accommodation area.

(11) In the accommodation area management device according to (10),

the information further includes information on a load loaded on the moving body or a towed object towed by the moving body; and

the accommodation position determination unit is configured to select the accommodation position based on the information on the size or the type of the moving body and the information on the load or the towed object.

According to the accommodation area management device of (11), since the accommodation position determination unit is configured to select the accommodation position based on the information on the load or the towed object in addition to the information on the size or the type of the moving body, even when the moving body is loading the load and towing the towed object, it is possible to prevent in advance the situation in which the moving body cannot be accommodated in the accommodation area and the situation in which the moving body cannot travel in the accommodation area.

(12) The accommodation area management device according to any one of (1) to (11), further includes:

a communication unit (communication unit 410) configured to communicate with the moving body or a terminal device (terminal device 300) of the user of the moving body, wherein

the reservation reception unit is configured to communicate with the user via the communication unit.

According to the accommodation area management device of (12), since the reservation reception unit receives the use reservation or the like via the communication unit, it is possible to smoothly communicate with the user.

(13) In the accommodation area management device according to any one of claims of (1) to (12),

the accommodation area includes a boarding area (boarding area PL) for allowing the user of the moving body to get on and off, and

the accommodation area is an automatic valet parking type accommodation area where the moving body is automatically driven at least between the boarding area and the accommodation position for accommodating the moving body.

According to the accommodation area management device of (13), since the accommodation area management device is required to control the exit and entry of the moving body in the automatic valet parking type accommodation area, the accommodation area management device acquires the information on the moving body in advance, thereby making it possible to smoothly perform entry processing, exit processing, or the like.

1. An accommodation area management device configured to manage an accommodation area for accommodating a moving body, the accommodation area management device comprising:
a reservation reception unit configured to receive a use reservation when the moving body uses the accommodation area; and
an accommodation position determination unit configured to determine an accommodation position of the moving body, wherein:
the reservation reception unit is configured to acquire information on the moving body when receiving the use reservation; and
the accommodation position determination unit is configured to set the accommodation position based on the information at the time of receiving the use reservation.

2. The accommodation area management device according to claim 1, wherein:
the accommodation position determination unit is configured to select a candidate accommodation position based on the information acquired by the reservation reception unit;
the accommodation position determination unit is configured to provide a user of the moving body with accommodation position information on the candidate accommodation position; and
the accommodation position determination unit is configured to set the candidate accommodation position as a confirmed accommodation position when the reservation reception unit acquires permission of the user regarding the accommodation position information.

3. The accommodation area management device according to claim 2, wherein
when the reservation reception unit acquires non-permission of the user regarding the accommodation position information, the accommodation position determination unit is configured to select another candidate accommodation position based on the information acquired by the reservation reception unit and provide the user with accommodation position information on the another candidate accommodation position.

4. The accommodation area management device according to claim 1, wherein:
the accommodation position determination unit is configured to select a plurality of candidate accommodation positions based on the information acquired by the reservation reception unit;
the accommodation position determination unit is configured to provide a user of the moving body with accommodation position information on the plurality of candidate accommodation positions; and
when the reservation reception unit acquires a designation of any one of the plurality of candidate accommodation positions, the accommodation position determination unit is configured to set the one of the plurality of candidate accommodation positions as a confirmed accommodation position.

5. The accommodation area management device according to claim 2, wherein
when the accommodation position determination unit sets the confirmed accommodation position, the reservation reception unit is configured to provide the user with an entry license permitting entry into the accommodation area.

6. The accommodation area management device according to claim 2, wherein
if the information acquired when the use reservation is received and information on the moving body when the moving body enters the accommodation area are different from each other, the accommodation position determination unit is configured to change the confirmed accommodation position.

7. The accommodation area management device according to claim 1, wherein
when there is no candidate accommodation position in the accommodation area, the reservation reception unit is configured to notify a user of the moving body that there is no accommodation position capable of accommodating the moving body.

8. The accommodation area management device according to claim 7, wherein
when there is no candidate accommodation position in the accommodation area, the reservation reception unit is configured to provide the user with accommodation area information on another accommodation area including an accommodation position capable of accommodating the moving body.

9. The accommodation area management device according to claim 7, wherein
when there is no candidate accommodation position in the accommodation area, the reservation reception unit is configured to provide the user with information on another moving body which can be accommodated.

10. The accommodation area management device according to claim 1, wherein:
the information includes information on a size or a type of the moving body; and
the accommodation position determination unit is configured to select the accommodation position capable of accommodating the moving body based on the information from among a plurality of accommodation positions provided in the accommodation area.

11. The accommodation area management device according to claim 10, wherein:
the information further includes information on a load loaded on the moving body or a towed object towed by the moving body; and
the accommodation position determination unit is configured to select the accommodation position based on the information on the size or the type of the moving body and the information on the load or the towed object.

12. The accommodation area management device according to claim 1, further comprising:
a communication unit configured to communicate with the moving body or a terminal device of a user of the moving body, wherein
the reservation reception unit is configured to communicate with the user via the communication unit.

13. The accommodation area management device according to claim 1, wherein:
the accommodation area includes a boarding area for allowing a user of the moving body to get on and off; and
the accommodation area is an automatic valet parking type accommodation area where the moving body is automatically driven at least between the boarding area and the accommodation position for accommodating the moving body.
